(19) United States
(12) Patent Application Publication
(10) Pub. No.: US 2013/0346088 A1
(43) Pub. Date: Dec. 26, 2013

(54) AUDIO CODING METHOD AND APPARATUS

(71) Applicant: Huawei Technologies Co., Ltd., Shenzhen (CN)

(72) Inventors: Lei Miao, Beijing (CN); Zexin Liu, Beijing (CN); Fengyan Qi, Shenzhen (CN)

(73) Assignee: Huawei Technologies Co., Ltd., Shenzhen (CN)

(21) Appl. No.: 14/010,103

(22) Filed: Aug. 26, 2013

Related U.S. Application Data
(63) Continuation of application No. PCT/CN2011/084816, filed on Dec. 28, 2011.

(30) Foreign Application Priority Data
Apr. 13, 2011 (CN) 201110092203.4

(51) Int. Cl. G10L 19/00

(52) U.S. Cl. CPC G10L 19/00
USPC 704/500

(57) ABSTRACT

An audio coding method and apparatus are disclosed, where the method includes: dividing an input audio signal into a low-band signal and a high-band signal; identifying types of the low-band signal and the high-band signal; adaptively allocating a total input rate of the audio signal to the low-band signal and the high-band signal according to different coding modes corresponding to the low-band signal and the high-band signal; and coding the low-band signal through a coding mode corresponding to the low-band signal according to the low-band rate, and coding the high-band signal through a coding mode corresponding to the high-band signal according to the high-band rate. In embodiments of the present application, when the low-band signal and the high-band signal are coded, coding rates are adaptively adjusted according to different types of the signals, thereby improving overall audio coding performance.

### CROSS-REFERENCE TO RELATED APPLICATIONS

This application is a continuation of International Application No. PCT/CN2011/084816, filed on Dec. 28, 2011, which claims priority to Chinese Patent Application No. 201110092203.4, filed on Apr. 13, 2011, both of which are hereby incorporated by reference in their entireties.

### TECHNICAL FIELD

The present application relates to the field of audio processing technologies, and in particularly, to an audio coding method and apparatus.

### BACKGROUND

Audio coding is a technology of coding a narrowband, a wideband, an ultra-wideband, and even an all-band audio signal. The wider a coding bandwidth is, the higher obtained user experience is. In an existing audio coding technology, a frequency band of a whole audio signal may be coded by adopting transform coding, for example, adopting an MDCT (Modified Discrete Cosine Transform, modified discrete cosine transform) coding manner, and uniform rate allocation is performed on the whole frequency band according to an available total input rate.

Because the audio signal may be further divided into a low-band signal and a high-band signal according to a characteristic of the audio signal, in existing coding and decoding technologies, the low-band signal and the high-band signal may also be coded separately, and during coding, a low-band coder and a high-band coder are used to perform, according to a given rate supported by each of the coders, corresponding coding operations on the low-band signal and the high-band signal. For example, in a case of the G.722B standard (G.722-SWB, G.722 super wideband extension) formulated by the ITU (International Telecommunication Union, International Telecommunication Union), if a total input rate is 80 kbit/s, a low-band rate fixedly allocated to the low-band signal is 64 kbit/s, and a high-band rate fixedly allocated to the high-band signal is 16 kbit/s.

It can be seen from the foregoing that, in an audio coding manner in the prior art, when a low-band signal and a high-band signal are coded, the coding can only be performed according to a rate given in the standard or a rate that is set before the coding. Because coding performance is limited by a coding rate, for audio signals of different types, for example, an audio signal and a music signal, if a fixed coding rate is adopted for coding, overall audio coding performance may be reduced.

### SUMMARY

Embodiments of the present application provide an audio coding method and apparatus, so as to solve a problem of low overall audio coding performance because only a preset or given rate can be adopted to code a high-band signal and a low-band signal in the prior art.

The embodiments of the present application disclose the following technical solutions.

An audio coding method includes:

dividing an input audio signal into a low-band signal and a high-band signal;

identifying types of the low-band signal and the high-band signal, where low-band signals and high-band signals of different types correspond to different coding modes respectively;

adaptively allocating a total input rate of the audio signal to the low-band signal and the high-band signal according to different coding modes corresponding to the low-band signal and the high-band signal, where a low-band rate is allocated to the low-band signal, and a high-band rate is allocated to the high-band signal; and

coding the low-band signal through a coding mode corresponding to the low-band signal according to the low-band rate, and coding the high-band signal through a coding mode corresponding to the high-band signal according to the high-band rate.

An audio coding apparatus includes:

a band dividing unit, configured to divide an input audio signal into a low-band signal and a high-band signal;

an identifying unit, configured to identify types of the low-band signal and the high-band signal, where low-band signals and high-band signals of different types correspond to different coding modes respectively;

an adaptive adjustment unit, configured to adaptively allocate a total input rate of the audio signal to the low-band signal and the high-band signal according to different coding modes corresponding to the low-band signal and the high-band signal, where a low-band rate is allocated to the low-band signal, and a high-band rate is allocated to the high-band signal; and

a coding unit, configured to code the low-band signal through a coding mode corresponding to the low-band signal according to the low-band rate, and code the high-band signal through a coding mode corresponding to the high-band signal according to the high-band rate.

It can be seen from the foregoing embodiments that, in the embodiments of the present application, the input audio signal is divided into the low-band signal and the high-band signal, the total input rate of the audio signal is adaptively allocated to the low-band signal and the high-band signal according to different coding modes corresponding to the low-band signal and the high-band signal, and the low-band signal is coded through the coding mode corresponding to the low-band signal according to the low-band rate, and the high-band signal is coded through the coding mode corresponding to the high-band signal according to the high-band rate. In the embodiments of the present application, when the low-band signal and the high-band signal are coded, the coding is not performed according to a rate given in the standard or set before the coding, and coding rates are adaptively adjusted according to different types of the signals, thereby improving overall audio coding performance.

### BRIEF DESCRIPTION OF DRAWINGS

To describe the technical solutions in the embodiments of the present application more clearly, the following briefly introduces accompanying drawings required for describing the embodiments. Apparently, persons of ordinary skill in the art may further obtain other drawings according to these accompanying drawings without creative efforts.

FIG. 1 is a flowchart of a first embodiment of a audio coding method according to the present application;

FIG. 2 is a schematic structural diagram of a coder for coding by adopting a method embodiment of the present application;

FIG. 3A and FIG. 3B is a flow chart of a second embodiment of a audio coding method according to the present application;

FIG. 4A and FIG. 4B is a flow chart of a third embodiment of a audio coding method according to the present application;

FIG. 5A and FIG. 5B is a flow chart of a fourth embodiment of a audio coding method according to the present application;

FIG. 6A and FIG. 6B is a flow chart of a fifth embodiment of a audio coding method according to the present application; and

FIG. 7 is a block diagram of an embodiment of a audio coding apparatus according to the present application.

### DESCRIPTION OF EMBODIMENTS

An audio coding method and apparatus are provided in the following embodiments of the present application. In the embodiments of the present application, a low-band rate and a high-band rate that are allocated to a low-band signal and a high-band signal are automatically adjusted according to a total input rate of an input audio signal, and types of the low-band signal and the high-band signal in the input audio signal, and adaptive coding is performed on the low-band signal and the high-band signal according to the allocated rates, thereby improving overall audio coding performance.

To make persons skilled in the art better understand the technical solutions in the embodiments of the present application, and make the foregoing objectives, features, and advantages of the embodiments of the present application more clearly, the following further describes the technical solutions in the embodiments of the present application in detail with reference to the accompanying drawings.

In the field of digital signal processing, an audio codec and a video codec are widely applied in various electronic devices, for example, a mobile phone, a wireless apparatus, a personal data assistant (PDA), a handheld or portable computer, a GPS receiver/navigator, a camera, an audio/video player, a camcorder, a video recorder, and a monitoring device. Usually, this type of electronic device includes an audio coder or an audio decoder, where the audio coder or decoder may be directly implemented by a digital circuit or a chip, for example, a DSP (digital signal processor), or be implemented by a software code driving a processor to execute a procedure in the software code.

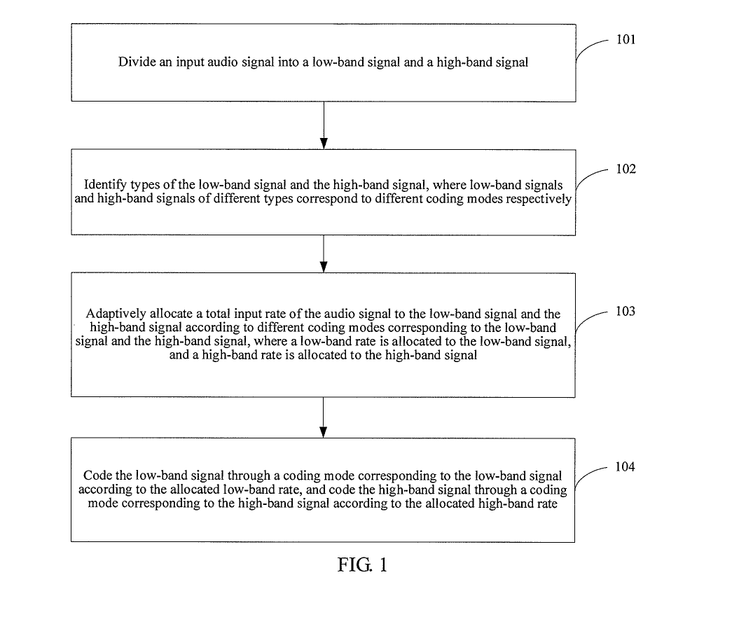

Referring to FIG. 1, FIG. 1 is a flow chart of a first embodiment of an audio coding method according to the present application.

Step 101: Divide an input audio signal into a low-band signal and a high-band signal.

Step 102: Identify types of the low-band signal and the high-band signal, where low-band signals and high-band signals of different types correspond to different coding modes respectively.

The low-band signal and the high-band signal are classified according to different signal characteristics, for example, the low-band signal may include a speech signal and an audio signal, where the speech signal may be further classified into an unvoiced signal, a voiced signal, a generic speech frame signal, an audio frame signal, and a transition frame signal; and the high-band signal may include a noise-like signal, a time domain abrupt change signal, a harmonic rich signal, and a general signal with a certain harmonic.

The signals that are classified and of different types correspond to different coding modes.

For example, coding modes corresponding to the speech signal and the audio signal are a speech coding mode and an audio coding mode respectively, where the speech coding mode includes, but is not limited to, the following modes: a UC (Unvoiced Coding, unvoiced coding) mode through which the unvoiced signal is coded, a VC (Voiced Coding, voiced coding) mode through which the voiced signal is coded, a GC (Generic Coding, generic coding) mode through which the generic speech frame and the generic audio frame are coded, and a TC (transition Coding, transition coding) mode through which the transition frame is coded.

Different coding modes corresponding to the high-band signal include, but are not limited to, the following modes: a Noise (noise) mode coding through which the noise-like signal is coded, a Transient (transient) mode coding through which the time domain abrupt change signal is coded, a Harmonic (harmonic) mode coding through which the harmonic rich signal is coded, and a Normal (normal) mode coding through which another signal with a certain harmonic is coded. The Normal mode may also be further classified according to a requirement and specified coding and decoding methods.

It should be noted that, the coding modes of the high-band signal and the low-band signal are all classified according to different types of the audio signal, and in an actual application process, it is not limited to the foregoing classification mode, that is, more coding modes may be obtained by further classification according to types of signals.

Step 103: Adaptively allocate a total input rate of the audio signal to the low-band signal and the high-band signal according to different coding modes corresponding to the low-band signal and the high-band signal, where a low-band rate is allocated to the low-band signal, and a high-band rate is allocated to the high-band signal.

Specifically, the total input rate of the audio signal may be adjusted level by level according to a preset low-band rate or high-band rate, and then be allocated to the low-band signal and the high-band signal.

In a case of a certain input rate, a coding rate of the low-band signal is preferentially ensured; when the coding mode corresponding to the type of the low-band signal is the UC mode, a lowest rate in a preset low-band rate set is used as the low-band rate and is allocated to the low-band signal; when the total input rate is greater than or equal to a preset first rate, a lowest rate in a high-band rate set is first used as an initial high-band rate and is allocated to the high-band signal; when a coding mode corresponding to the high-band signal accords with a rate adjustment type, the high-band rate is adjusted level by level, and an adjustment rate which corresponds to the coding mode of the high-band signal and is greater than the initial high-band rate is used as the high-band rate and is allocated to the high-band signal. In another implementation manner, another adjustment may be performed according to different coding modes corresponding to the high-band signal and the low-band signal, and the coding rate of the low-band signal is preferentially ensured; when the total input rate is high, an adjustment is performed on the high-band rate by using the lowest rate in the high-band rate set as a starting point; when a coding mode corresponding to the low-band signal is a coding mode occupying a lowest rate, the lowest rate in the low-band rate set is allocated to the low-band signal.

A difference between the embodiment of the present application and the prior art lies in that, the low-band signal and the high-band signal are not coded according to a preset given rate, the rates of the low-band signal and the high-band signal are adaptively adjusted according to the types of the low-band signal and the high-band signal, and a specific adjustment process is described in detail in a subsequent embodiment.

Step 104: Code the low-band signal through the coding mode corresponding to the low-band signal according to the allocated low-band rate, and code the high-band signal through the coding mode corresponding to the high-band signal according to the allocated high-band rate.

It can be seen from the foregoing embodiment that, when the low-band signal and the high-band signal are coded, the coding is not performed according to a rate given in the standard or preset before the coding, and coding rates are adaptively adjusted according to different types of the signals, thereby improving overall audio coding performance.

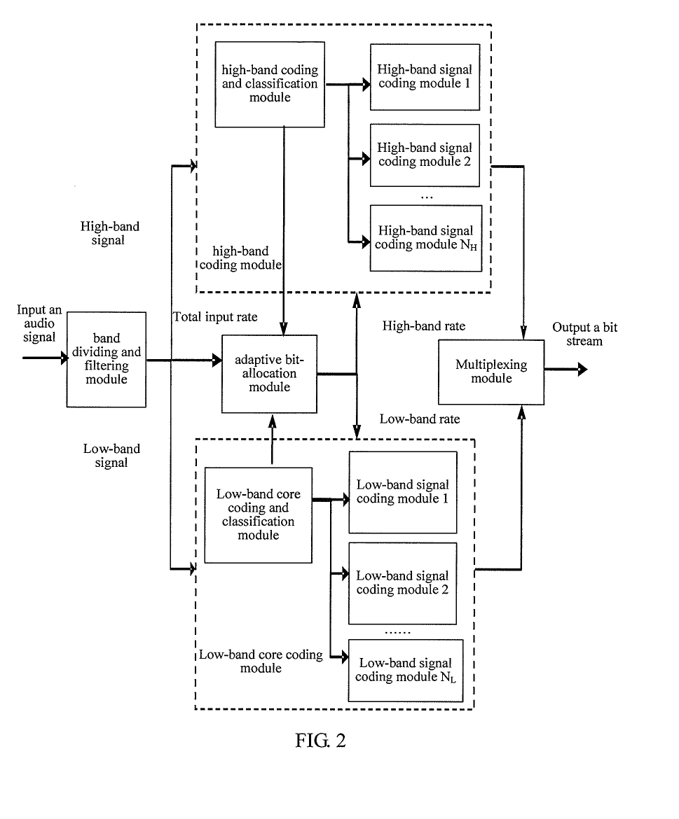

Referring to FIG. 2, FIG. 2 is a schematic structural diagram of a coder for coding by adopting an audio coding method embodiment of the present application.

The coder includes: a band dividing and filtering module, an adaptive bit-allocation module, a high-band coding module, a low-band core coding module, and a multiplexing module. The high-band coding module further includes a high-band coding and classification module and N_{H} high-band signal coding modules, and the low-band core coding module further includes a low-band core coding and classification module and N_{L} low-band signal coding modules. The N_{H} high-band signal coding modules correspond to N_{H} types of high-band signals, and the N_{L} low-band signal coding modules correspond to N_{L} types of low-band signals.

An input audio signal is divided into a high-band signal and a low-band signal after being processed by the band dividing and filtering module, where the high-band signal is input to the high-band coding module, and a high-band coding and classification module in the high-band coding module identifies a type of the high-band signal, so that a high-band signal coding module is allocated to the high-band signal according to the type of the high-band signal; and the low-band signal is input to the low-band core coding module, and a low-band coding and classification module in the low-band core coding module identifies a type of the low-band signal, so that a low-band signal coding module is allocated to the low-band signal according to the type of the low-band signal. Meanwhile, the adaptive bit-allocation module adaptively allocates a total input rate to the low-band signal and the high-band signal according to the identified types of the low-band signal and the high-band signal.

A process of adaptively allocating a low-band rate and a high-band rate is described in detail in the following with reference to a specific application embodiment.

For the convenience of description of the application embodiment, it is first assumed that a preset total audio coding input rate set includes M total input rates, namely, B₁, B₂, . . . B_{M}. A preset low-band rate set includes P low-band rates, namely, B_{L1}, B_{L2}, . . . B_{LP}, where B_{L1}<B_{L2} . . . <B_{LP}; and a preset high-band rate set includes Q high-band rates, namely, B_{H1}, B_{H2}, . . . , B_{HQ}, where B_{H1}<B_{H2} . . . <B_{HQ}, and B_{H1} may be 0, that is, in order to ensure overall quality, the low-band signal may be merely coded, while the high-band signal may not be coded. A total rate of a combination of any one of the low-band rates and any one of the high-band rates corresponds to a rate in the total rates B₁, B₂, . . . , B_{M}, namely, Bₖ=B_{Li}+B_{Hj}, where i=1, 2, . . . , P; j=1, 2, . . . , Q; and k=1, 2, . . . , M. In addition, B_{M}=B_{LP}+B_{HQ}, and B₁=B_{L1}+B_{H1}.

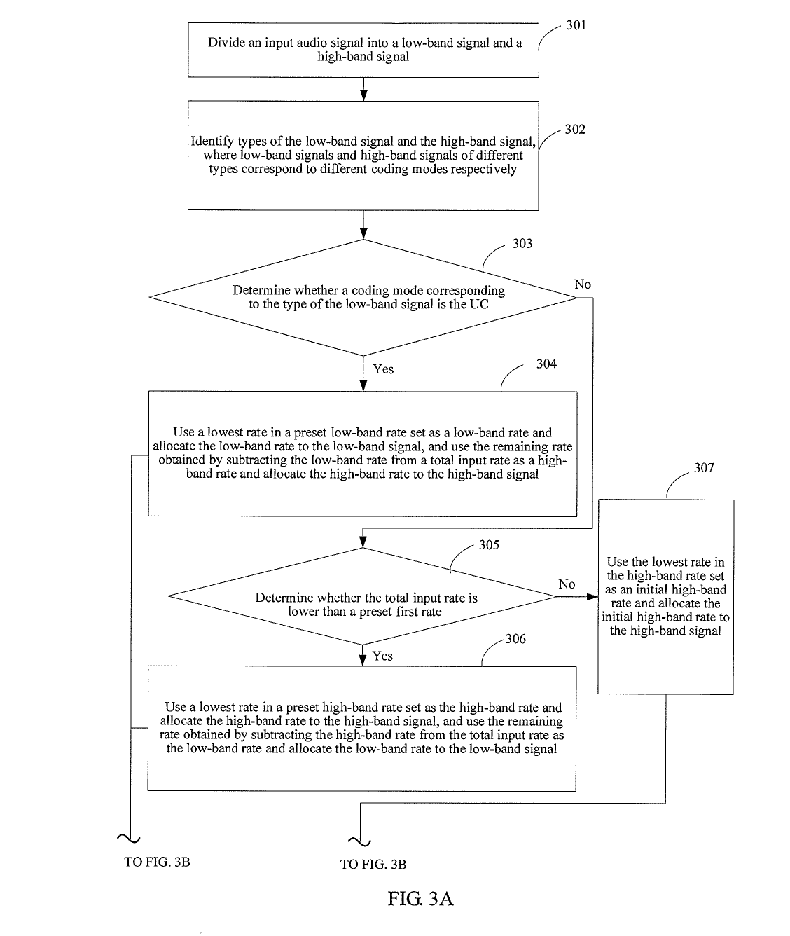

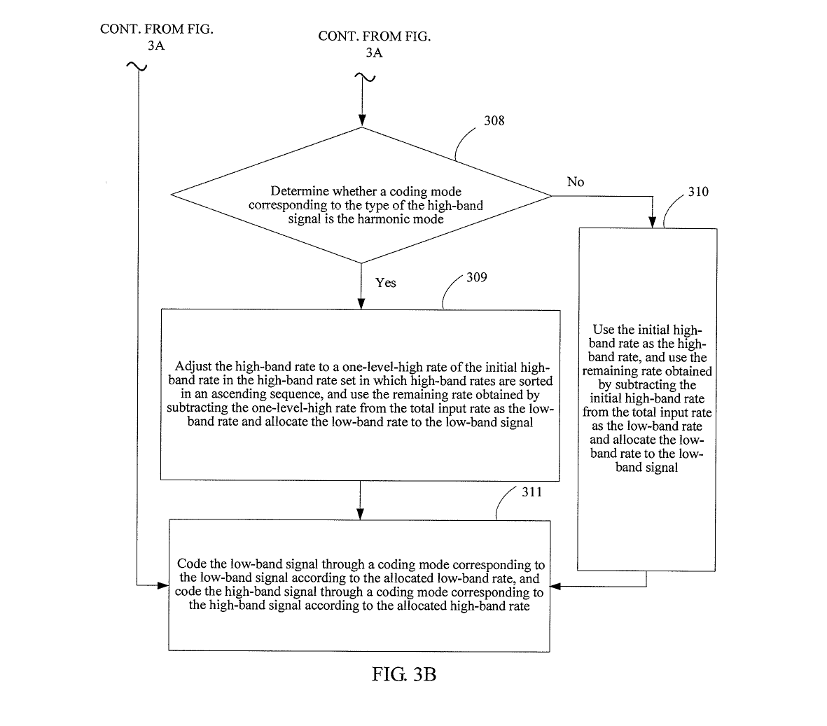

Referring to FIG. 3A and FIG. 3B, FIG. 3A and FIG. 3B is a flow chart of a second embodiment of a audio coding method according to the present application. The embodiment shows a coding process in which a low-band signal merely includes a speech signal.

Step 301: Divide an input audio signal into a low-band signal and a high-band signal.

Step 302: Identify types of the low-band signal and the high-band signal, where low-band signals and high-band signals of different types correspond to different coding modes respectively.

In the embodiment of the present application, only a speech (speech) coding mode is used in coding the low-band signal, for example, a CELP (Code Excited Linear Prediction, code excited linear prediction) coding mode. The speech coding mode includes: a UC mode through which an unvoiced signal is coded, a VC mode through which a voiced signal is coded, a GC mode through which a generic speech frame and a generic audio frame are coded, and a TC mode through which a transition frame is coded.

Coding modes corresponding to the high-band signals of different types include: a Noise mode through which a noise-like signal is coded, a Transient coding mode through which a time domain abrupt change signal is coded, a Harmonic mode through which a harmonic rich signal is coded, and a Normal mode through which another signal with a certain harmonic is coded. The Normal mode may also be further classified according to a requirement and specified coding and decoding methods.

Step 303: Determine whether a coding mode corresponding to the type of the low-band signal is the UC, and if yes, perform step 304; otherwise, perform step 305.

Step 304: Use a lowest rate in a preset low-band rate set as a low-band rate and allocate the low-band rate to the low-band signal, use the remaining rate obtained by subtracting the low-band rate from a total input rate as a high-band rate and allocate the high-band rate to the high-band signal, and perform step 311.

When the coding mode of the low-band signal is the UC, assuming that the total input rate is Bᵢ (where i=1, . . . , M), the low-band rate of the low-band signal is set to B_{L1}, and the high-band rate of the high-band signal is correspondingly set to Bᵢ−B_{L1}.

Step 305: Determine whether the total input rate is lower than a preset first rate, and if yes, perform step 306; otherwise, perform step 307.

Assuming that the total input rate is Bᵢ (where i=1, . . . , M), it is determined whether Bᵢ is lower than the preset first rate, where the preset first rate may be a total input rate at the first one third of a total input rate set after all total input rates in the total input rate set are sorted in an ascending sequence, for example, if the total input rates in the total input rate set are B₁, B₂, B₃, B₄, B₅, and B₆ after being sorted in an ascending sequence, the preset first rate may be set to B₂.

Step 306: Use a lowest rate in a preset high-band rate set as the high-band rate and allocate the high-band rate to the high-band signal, use the remaining rate obtained by subtracting the high-band rate from the total input rate as the low-band rate and allocate the low-band rate to the low-band signal, and perform step 311.

When the total input rate Bᵢ is lower than the preset first rate, the high-band rate of the high-band signal is set to B_{H1}, and the low-band rate of the low-band signal is correspondingly set to Bᵢ−B_{H1}.

Step 307: Use the lowest rate in the high-band rate set as an initial high-band rate and allocate the initial high-band rate to the high-band signal.

When the coding mode of the low-band signal is not the UC, and the total input rate Bᵢ is not lower than the preset first rate, the high-band rate of the high-band signal may be set to B_{H1}, where B_{H1} is the lowest rate in the high-band rate set, so that it may be ensured that a higher rate is allocated to the low-band signal, thereby better ensuring quality of the low-band signal.

In addition to setting the high-band rate of the high-band signal to B_{H1} as described above, the initial high-band rate may also be set to a rate which is in the high-band rate set and is close to a result of Bᵢ*alpha1, where alpha1 may be a preset value, for example, may be ⅓; or, the low-band rate may also be first set to a rate which is in the low-band rate set and is close to a result of Bᵢ*alpha2, where alpha2 may be a preset value, for example, may be ⅔, and correspondingly, the initial high-band rate is Bᵢ−Bᵢ*alpha2. There may be multiple manners for setting the initial high-band rate, which are not limited in the embodiment of the present application.

Step 308: Determine whether a coding mode corresponding to the type of the high-band signal is the Harmonic mode, and if yes, perform step 309; otherwise, perform step 310.

Step 309: Adjust the high-band rate to a one-level-high rate of the initial high-band rate in the high-band rate set in which high-band rates are sorted in an ascending sequence, use the remaining rate obtained by subtracting the one-level-high rate from the total input rate as the low-band rate and allocate the low-band rate to the low-band signal, and perform step 311.

When the coding mode corresponding to the type of the high-band signal is the Harmonic mode, the high-band rate of the high-band signal is adjusted upward from currently set B_{H1} to B_{H2}, and correspondingly, the low-band rate of the low-band signal is Bᵢ−B_{H2}.

It should be noted that, when the total input rate Bᵢ is not lower than the preset first rate, during a rate adjustment, the high-band rate may be adjusted from a currently set rate to a one-level-high rate of the currently set rate in the high-band rate set. It can be known that, the objective of the embodiment of the present application is to show a manner for adjusting the rate level by level, which is not used to limit a specific value of an initially set rate.

Step 310: Use the initial high-band rate as the high-band rate, and use the remaining rate obtained by subtracting the initial high-band rate from the total input rate as the low-band rate and allocate the low-band rate to the low-band signal.

When the coding mode corresponding to the type of the high-band signal is not the Harmonic mode, the high-band rate of the high-band signal is not adjusted and is still B_{H1}, and correspondingly, the low-band rate of the low-band signal is Bᵢ−B_{H1}.

Step 311: Code the low-band signal through a coding mode corresponding to the low-band signal according to the allocated low-band rate, and code the high-band signal through a coding mode corresponding to the high-band signal according to the allocated high-band rate.

Processes for coding the high-band signal and the low-band signal in the present application are the same as those in the prior art, and are not repeatedly described here. Code streams after the high-band signal and the low-band signal are coded are multiplexed subsequently, and then a composite bit stream is output, thereby completing the coding processes.

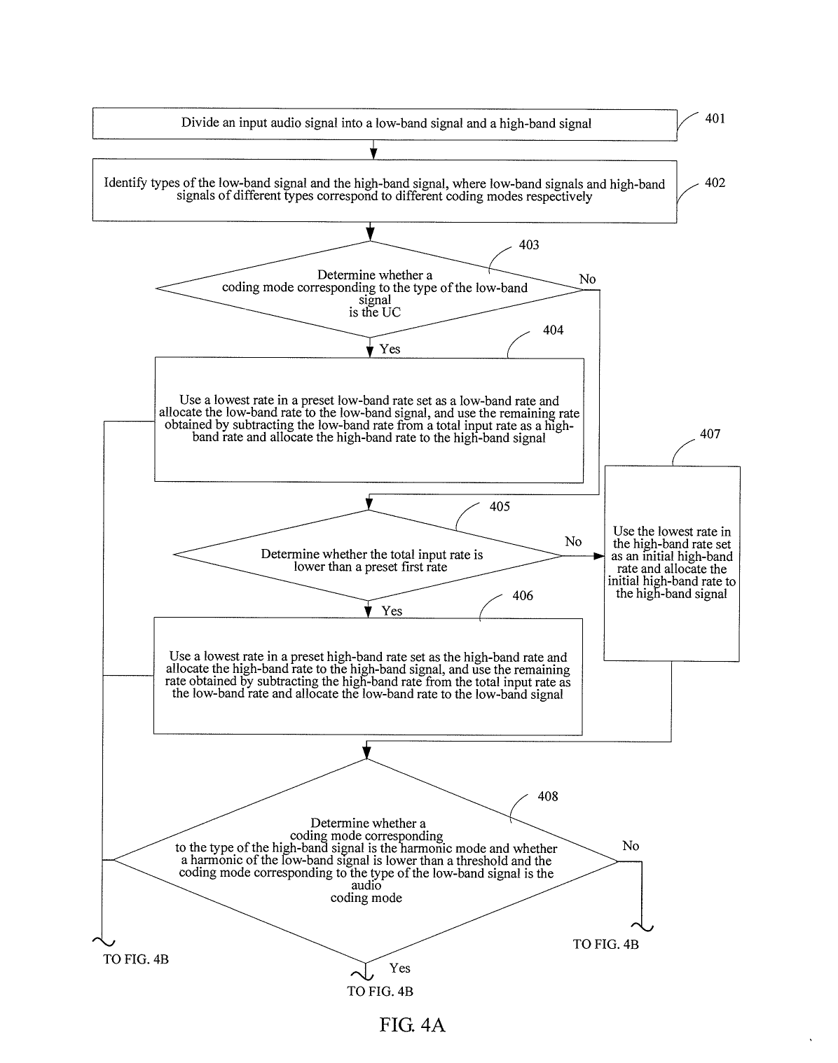

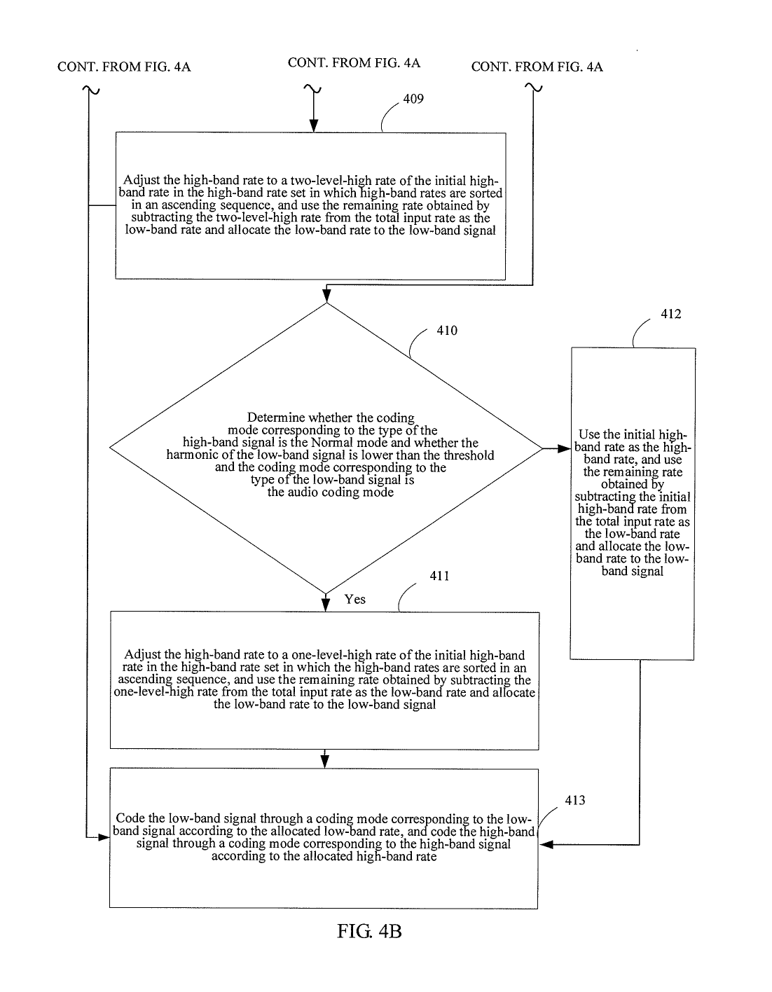

Referring to FIG. 4A and FIG. 4B, FIG. 4A and FIG. 4B is a flow chart of a third embodiment of a audio coding method according to the present application. The embodiment shows a coding process in which a low-band signal includes a speech signal and a music signal.

Step 401: Divide an input audio signal into a low-band signal and a high-band signal.

Step 402: Identify types of the low-band signal and the high-band signal, where low-band signals and high-band signals of different types correspond to different coding modes respectively.

In the embodiment of the present application, a speech (speech) coding mode may be used in coding the low-band signal, for example, a CELP coding mode. The speech coding mode includes: a UC mode through which an unvoiced signal is coded, a VC mode through which a voiced signal is coded, a GC mode through which a generic speech frame and a generic audio frame are coded, and a TC mode through which a transition frame is coded. The low-band signal may also use an audio (audio) coding mode.

Coding modes corresponding to the high-band signals of different types include: a Noise mode through which a noise-like signal is coded, a Transient coding mode through which a time domain abrupt change signal is coded, a Harmonic mode through which a harmonic rich signal is coded, and a Normal mode through which a signal with a certain harmonic is coded. The Normal mode may also be further classified according to a requirement and specified coding and decoding methods.

Step 403: Determine whether a coding mode corresponding to the type of the low-band signal is the UC, and if yes, perform step 404; otherwise, perform step 405.

Step 404: Use a lowest rate in a preset low-band rate set as a low-band rate and allocate the low-band rate to the low-band signal, use the remaining rate obtained by subtracting the low-band rate from a total input rate as a high-band rate and allocate the high-band rate to the high-band signal, and perform step 413.

When the coding mode of the low-band signal is the UC, assuming that the total input rate is Bᵢ (where i=1, . . . , M), the low-band rate of the low-band signal is set to B_{L1}, and the high-band rate of the high-band signal is correspondingly set to Bᵢ−B_{L1}.

Step 405: Determine whether the total input rate is lower than a preset first rate, and if yes, perform step 406; otherwise, perform step 407.

Assuming that the total input rate is Bᵢ (where i=1, . . . , M), it is determined whether Bᵢ is lower than the preset first rate, where the preset first rate may be a total input rate at the first one third of a total input rate set after all total input rates in the total input rate set are sorted in an ascending sequence, for example, if the total input rates in the total input rate set are B₁, B₂, B₃, B₄, B₅, and B₆ after being sorted in an ascending sequence, the preset first rate may be set to B₂.

Step 406: Use a lowest rate in a preset high-band rate set as the high-band rate and allocate the high-band rate to the high-band signal, use the remaining rate obtained by subtracting the high-band rate from the total input rate as the low-band rate and allocate the low-band rate to the low-band signal, and perform step 413.

When the total input rate Bᵢ is lower than the preset first rate, the high-band rate of the high-band signal is set to B_{H1}, and the low-band rate of the low-band signal is correspondingly set to B₁−B_{H1}.

Step 407: Use the lowest rate in the high-band rate set as an initial high-band rate and allocate the initial high-band rate to the high-band signal.

When the coding mode of the low-band signal is not the UC, and the total input rate Bᵢ is not lower than the preset first rate, the high-band rate of the high-band signal may be set to B_{H1}, where B_{H1} is the lowest rate in the high-band rate set, so that it may be ensured that a higher rate is allocated to the low-band signal, thereby better ensuring quality of the low-band signal.

In addition to setting the high-band rate of the high-band signal to B_{H1} as described above, the initial high-band rate may also be set to a rate which is in the high-band rate set and is close to a result of Bᵢ*alpha1, where alpha1 may be a preset value, for example, may be ⅓; or, the low-band rate may also be first set to a rate which is in the low-band rate set and is close to a result of Bᵢ*alpha2, where alpha2 may be a preset value, for example, may be ⅔, and correspondingly, the initial high-band rate is Bᵢ−Bᵢ*alpha2. There may be multiple manners for setting the initial high-band rate, which are not limited in the embodiment of the present application.

Step 408: Determine whether a coding mode corresponding to the type of the high-band signal is the Harmonic mode and whether a harmonic of the low-band signal is lower than a threshold and the coding mode corresponding to the type of the low-band signal is the audio coding mode, and if yes, perform step 409; otherwise, perform step 410.

In this embodiment, determining whether the harmonic of the low-band signal is lower than the threshold is to determine whether the harmonic of the low-band signal is high. The harmonic of the low-band signal may be obtained by performing spectrum analysis on the low-band signal, and specifically may be obtained through a peak-to-average ratio parameter, where the peak-to-average ratio parameter may be a ratio of a maximum value to an average value of a current sub-band spectrum, and a higher ratio means a richer harmonic. A process for determining whether the harmonic is rich is the same as that in the prior art, and is not repeatedly described here.

Step 409: Adjust the high-band rate to a two-level-high rate of the initial high-band rate in the high-band rate set in which high-band rates are sorted in an ascending sequence, use the remaining rate obtained by subtracting the two-level-high rate from the total input rate as the low-band rate and allocate the low-band rate to the low-band signal, and perform step 413.

When the coding mode corresponding to the type of the high-band signal is the Harmonic mode, and the coding mode corresponding to the type of the low-band signal is the audio mode and the harmonic of the low-band signal is lower than the threshold, the high-band rate of the high-band signal is adjusted upward from currently set B_{H1} to B_{H3}, and correspondingly, the low-band rate of the low-band signal is Bᵢ−B_{H3}.

It should be noted that, when the total input rate Bᵢ is not lower than the preset first rate, during a rate adjustment, the high-band rate may be adjusted from a currently set rate to a one-level-high rate of the currently set rate in the high-band rate set. It can be known that, the objective of the embodiment of the present application is to show a manner for adjusting the rate level by level, which is not used to limit a specific value of an initially set rate.

Step 410: Determine whether the coding mode corresponding to the type of the high-band signal is the Normal mode and whether the harmonic of the low-band signal is lower than the threshold and the coding mode corresponding to the type of the low-band signal is the audio coding mode, and if yes, perform step 411; otherwise, perform step 412.

Step 411: Adjust the high-band rate to a one-level-high rate of the initial high-band rate in the high-band rate set in which the high-band rates are sorted in an ascending sequence, use the remaining rate obtained by subtracting the one-level-high rate from the total input rate as the low-band rate and allocate the low-band rate to the low-band signal, and perform step 413.

When the coding mode corresponding to the type of the high-band signal is the Normal mode, the harmonic of the low-band signal is lower than the threshold, and the coding mode corresponding to the type of the low-band signal is the audio coding mode, the high-band rate of the high-band signal is adjusted upward from the currently set B_{H1} to B_{H2}, and correspondingly, the low-band rate of the low-band signal is Bᵢ−B_{H2}.

Step 412: Use the initial high-band rate as the high-band rate, and use the remaining rate obtained by subtracting the initial high-band rate from the total input rate as the low-band rate and allocate the low-band rate to the low-band signal.

Step 413: Code the low-band signal through a coding mode corresponding to the low-band signal according to the allocated low-band rate, and code the high-band signal through a coding mode corresponding to the high-band signal according to the allocated high-band rate.

Processes for coding the high-band signal and the low-band signal in the present application are the same as those in the prior art, and are not repeatedly described here. Code streams after the high-band signal and the low-band signal are coded are multiplexed subsequently, and then a composite bit stream is output, thereby completing the coding processes.

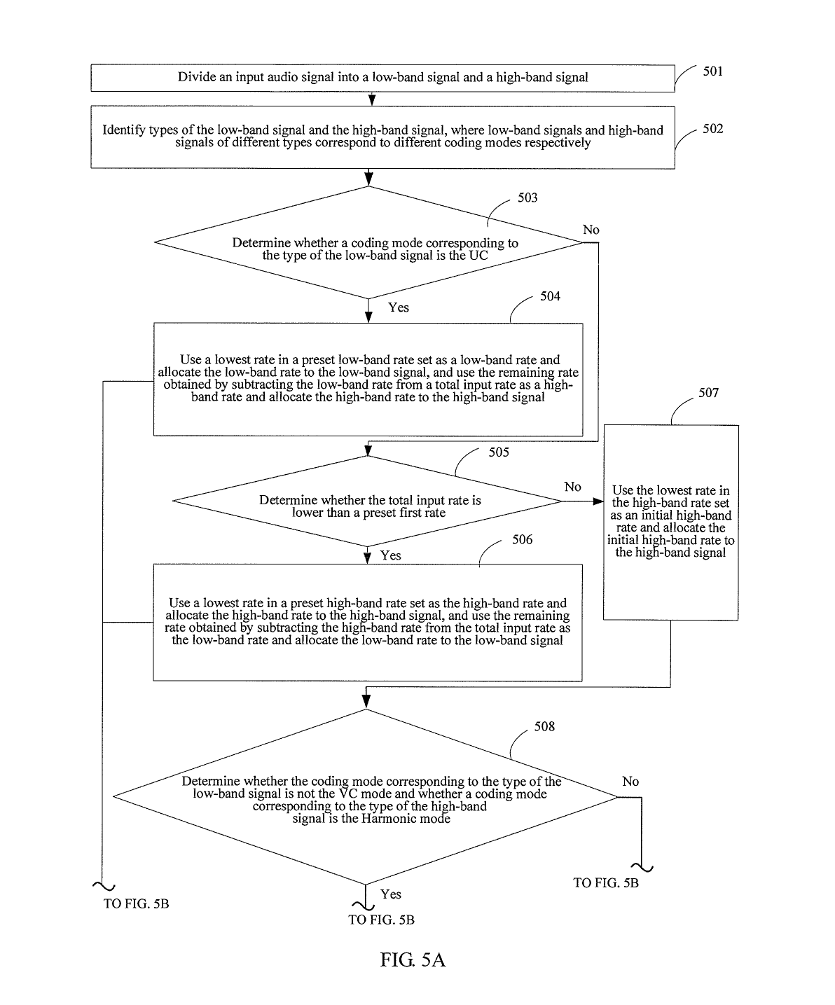

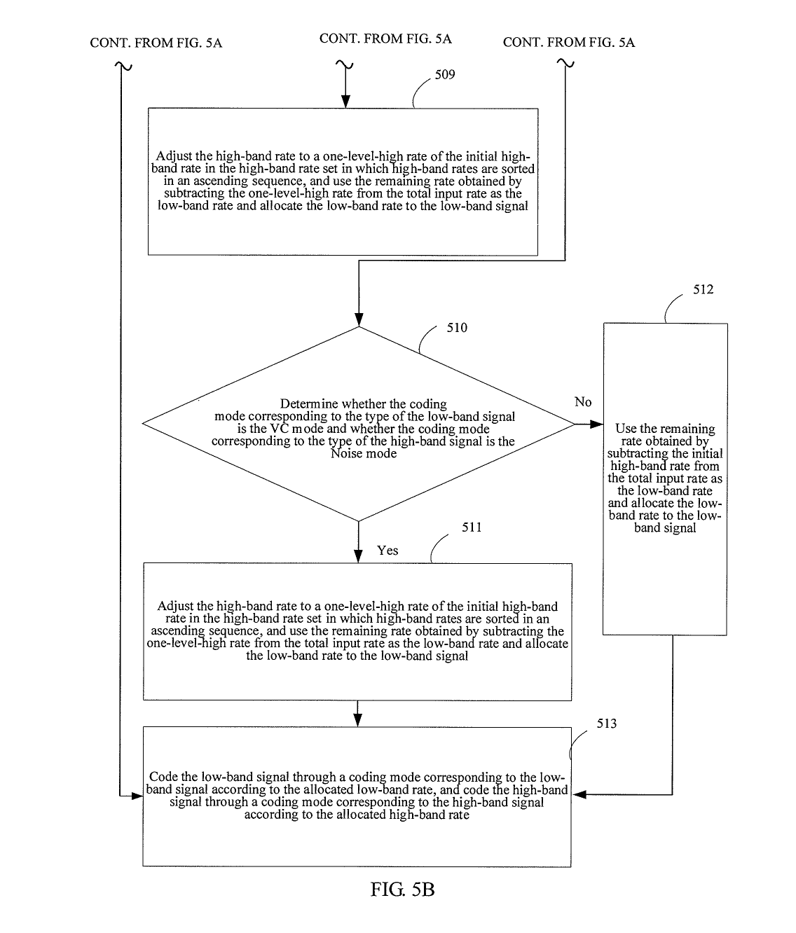

Referring to FIG. 5A and FIG. 5B, FIG. 5A and FIG. 5B is a flowchart of a fourth embodiment of a audio coding method according to the present application. The embodiment shows another coding process in which a low-band signal only includes a speech signal.

Step 501: Divide an input audio signal into a low-band signal and a high-band signal.

Step 502: Identify types of the low-band signal and the high-band signal, where low-band signals and high-band signals of different types correspond to different coding modes respectively.

In the embodiment of the present application, only a speech (speech) coding mode is used in coding the low-band signal, for example, a CELP coding mode. The speech coding mode includes: a UC mode through which an unvoiced signal is coded, a VC mode through which a voiced signal is coded, a GC mode through which a generic speech frame and a generic audio frame are coded, and a TC mode through which a transition frame is coded.

Coding modes corresponding to the high-band signals of different types include: a Noise mode through which a noise-like signal is coded, a Transient coding mode through which a time domain abrupt change signal is coded, a Harmonic mode through which a harmonic rich signal is coded, and a Normal mode through which another signal with a certain harmonic is coded. The Normal mode may also be further classified according to a requirement and specified coding and decoding methods.

Step 503: Determine whether a coding mode corresponding to the type of the low-band signal is the UC, and if yes, perform step 504; otherwise, perform step 505.

Step 504: Use a lowest rate in a preset low-band rate set as a low-band rate and allocate the low-band rate to the low-band signal, use the remaining rate obtained by subtracting the low-band rate from a total input rate as a high-band rate and allocate the high-band rate to the high-band signal, and perform step 513.

When the coding mode of the low-band signal is the UC, assuming that the total input rate is Bᵢ (where i=1, . . . , M), the low-band rate of the low-band signal is set to B_{L1}, and the high-band rate of the high-band signal is correspondingly set to Bᵢ−B_{L1}.

Step 505: Determine whether the total input rate is lower than a preset first rate, and if yes, perform step 506; otherwise, perform step 507.

Assuming that the total input rate is Bᵢ (where i=1, . . . , M), it is determined whether Bᵢ is lower than the preset first rate, where the preset first rate may be a total input rate at the first one third of a total input rate set after all total input rates in the total input rate set are sorted in an ascending sequence, for example, if the total input rates in the total input rate set are B₁, B₂, B₃, B₄, B₅, and B₆ after being sorted in an ascending sequence, the preset first rate may be set to B₂.

Step 506: Use a lowest rate in a preset high-band rate set as the high-band rate and allocate the high-band rate to the high-band signal, use the remaining rate obtained by subtracting the high-band rate from the total input rate as the low-band rate and allocate the low-band rate to the low-band signal, and perform step 513.

When the total input rate Bᵢ is lower than the preset first rate, the high-band rate of the high-band signal is set to B_{H1}, and the low-band rate of the low-band signal is correspondingly set to Bᵢ−B_{H1}.

Step 507: Use the lowest rate in the high-band rate set as an initial high-band rate and allocate the initial high-band rate to the high-band signal.

When the coding mode of the low-band signal is not the UC, and the total input rate Bᵢ is not lower than the preset first rate, the high-band rate of the high-band signal may be set to B_{H1}, where B_{H1} is the lowest rate in the high-band rate set, so that it may be ensured that a higher rate is allocated to the low-band signal, thereby better ensuring quality of the low-band signal.

In addition to setting the high-band rate of the high-band signal to B_{H1} as described above, the initial high-band rate may also be set to a rate which is in the high-band rate set and is close to a result of Bᵢ*alpha1, where alpha1 may be a preset value, for example, may be ⅓; or, the low-band rate may also be first set to a rate which is in the low-band rate set and is close to a result of Bᵢ*alpha2, where alpha2 may be a preset value, for example, may be ⅔, and correspondingly, the initial high-band rate is Bᵢ−Bi*alpha2. There may be multiple manners for setting the initial high-band rate, which are not limited in the embodiment of the present application.

Step 508: Determine whether the coding mode corresponding to the type of the low-band signal is not the VC mode and whether a coding mode corresponding to the type of the high-band signal is the Harmonic mode, and if yes, perform step 509; otherwise, perform step 510.

Step 509: Adjust the high-band rate to a one-level-high rate of the initial high-band rate in the high-band rate set in which high-band rates are sorted in an ascending sequence, use the remaining rate obtained by subtracting the one-level-high rate from the total input rate as the low-band rate and allocate the low-band rate to the low-band signal, and perform step 513.

When the coding mode corresponding to the type of the low-band signal is not the VC mode, and the coding mode corresponding to the type of the high-band signal is the Harmonic mode, the high-band rate of the high-band signal is adjusted upward from currently set B_{H1} to B_{H2}, and correspondingly, the low-band rate of the low-band signal is Bᵢ−B_{H2}.

It should be noted that, when the total input rate Bᵢ is not lower than the preset first rate, during a rate adjustment, the high-band rate may be adjusted from a currently set rate to a one-level-high rate of the currently set rate in the high-band rate set. It can be known that, the objective of the embodiment of the present application is to show a manner for adjusting the rate level by level, which is not used to limit a specific value of an initially set rate.

Step 510: Determine whether the coding mode corresponding to the type of the low-band signal is the VC mode and whether the coding mode corresponding to the type of the high-band signal is the Noise mode, and if yes, perform step 511; otherwise, perform step 512.

Step 511: Adjust the high-band rate to a one-level-high rate of the initial high-band rate in the high-band rate set in which the high-band rates are sorted in an ascending sequence, use the remaining rate obtained by subtracting the one-level-high rate from the total input rate as the low-band rate and allocate the low-band rate to the low-band signal, and perform step 513.

When the coding mode corresponding to the type of the low-band signal is the VC mode, and the coding mode corresponding to the type of the high-band signal is the Noise mode, the high-band rate of the high-band signal is adjusted upward from the currently set B_{H1} to B_{H2}, and correspondingly, the low-band rate of the low-band signal is Bᵢ−B_{H2}.

It should be noted that, when an initially set high-band rate is not the lowest rate in the high-band rate set, during the rate adjustment, the high-band rate may be adjusted from the currently set rate to a one-level-high rate of the currently set rate in the high-band rate set. It can be known that, the objective of the embodiment of the present application is to show the manner for adjusting the rate level by level, which is not used to limit the specific value of the initially set rate.

Step 512: Use the remaining rate obtained by subtracting the initial high-band rate from the total input rate as the low-band rate and allocate the low-band rate to the low-band signal.

When the coding mode corresponding to the type of the low-band signal is the VC mode, and the coding mode corresponding to the type of the high-band signal is neither the Harmonic mode nor the Noise mode, the high-band rate of the high-band signal is not adjusted and is still B_{H1}, and correspondingly, the low-band rate of the low-band signal is Bᵢ−B_{H1}.

Step 513: Code the low-band signal through a coding mode corresponding to the low-band signal according to the allocated low-band rate; and code the high-band signal through a coding mode corresponding to the high-band signal according to the allocated high-band rate.

Processes for coding the high-band signal and the low-band signal in the present application are the same as those in the prior art, and are not repeatedly described here. Code streams after the high-band signal and the low-band signal are coded are multiplexed subsequently, and then a composite bit stream is output, thereby completing the coding processes.

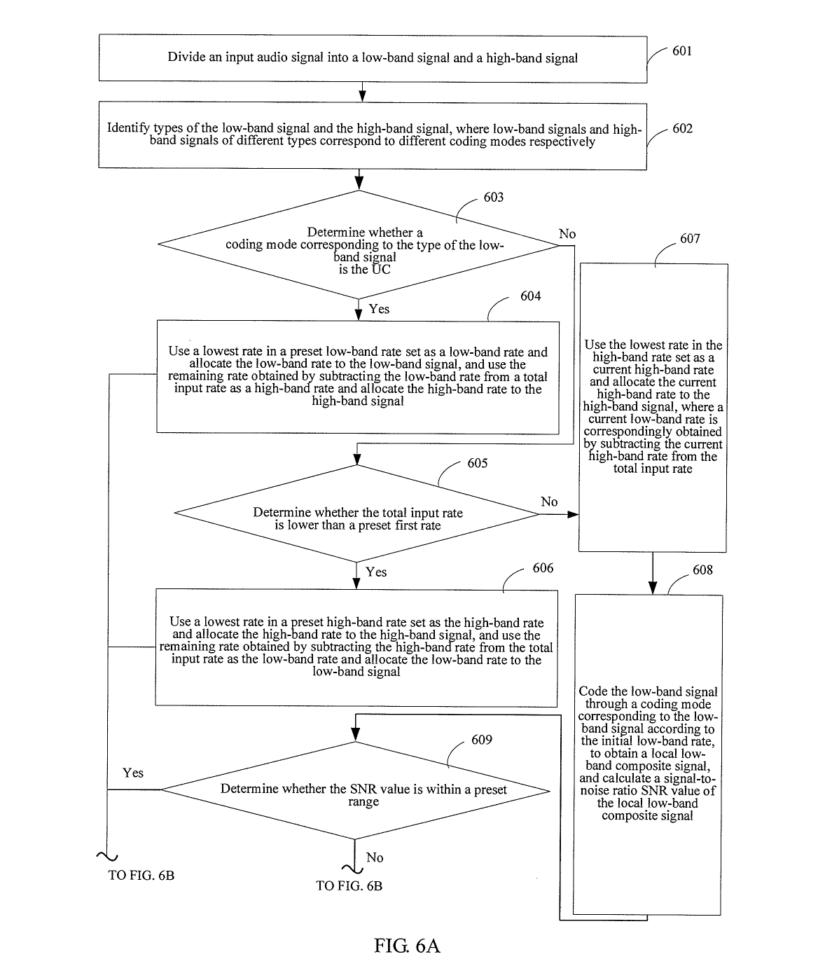

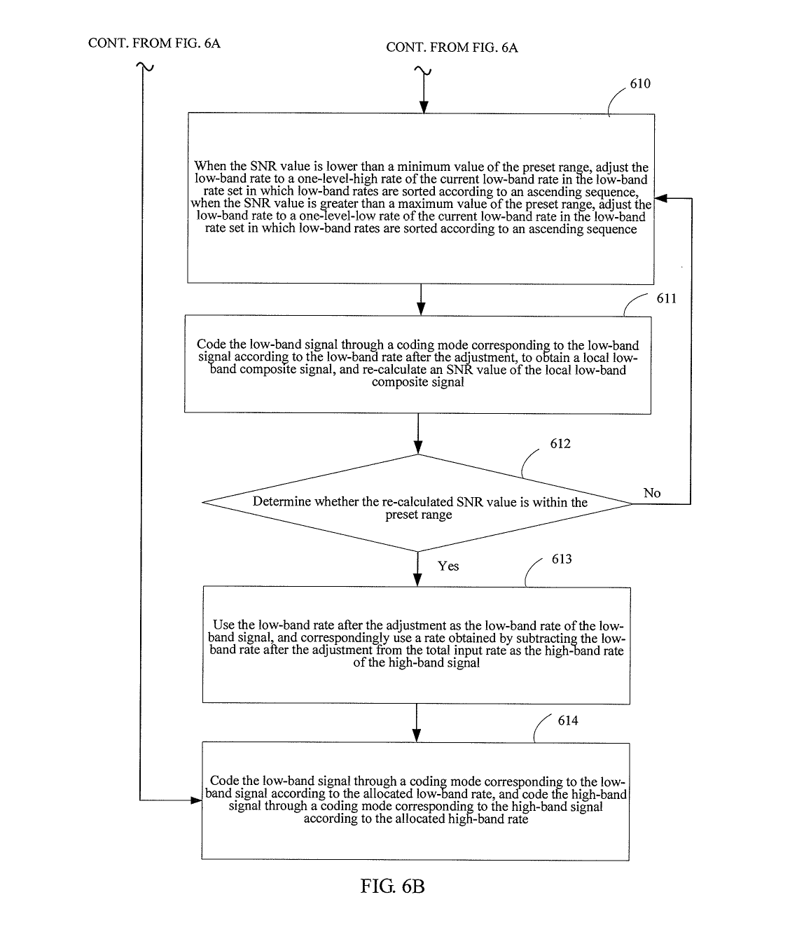

Referring to FIG. 6A and FIG. 6B, FIG. 6A and FIG. 6B is a flow chart of a fifth embodiment of a audio coding method according to the present application. The embodiment shows another coding process in which a low-band signal only includes a audio signal.

Step 601: Divide an input audio signal into a low-band signal and a high-band signal.

Step 602: Identify types of the low-band signal and the high-band signal, where low-band signals and high-band signals of different types correspond to different coding modes respectively.

In the embodiment of the present application, only a speech (speech) coding mode is used in coding the low-band signal, for example, a CELP coding mode. The audio coding mode includes: a UC mode through which an unvoiced signal is coded, a VC mode through which a voiced signal is coded, a GC mode through which a generic speech frame and a generic audio frame are coded, and a TC mode through which a transition frame is coded.

Coding modes corresponding to the high-band signals of different types include: a Noise mode through which a noise-like signal is coded, a Transient coding mode through which a time domain abrupt change signal is coded, a Harmonic mode through which a harmonic rich signal is coded, and a Normal mode through which another signal with a certain harmonic is coded. The Normal mode may also be further classified according to a requirement and specified coding and decoding methods.

Step 603: Determine whether a coding mode corresponding to the type of the low-band signal is the UC, and if yes, perform step 604; otherwise, perform step 605.

Step 604: Use a lowest rate in a preset low-band rate set as a low-band rate and allocate the low-band rate to the low-band signal, use the remaining rate obtained by subtracting the low-band rate from a total input rate as a high-band rate and allocate the high-band rate to the high-band signal, and perform step 614.

When the coding mode of the low-band signal is the UC, assuming that the total input rate is Bᵢ (where i=1, . . . , M), the low-band rate of the low-band signal is set to B_{L1}, and the high-band rate of the high-band signal is correspondingly set to Bᵢ−B_{L1}.

Step 605: Determine whether the total input rate is lower than a preset first rate, and if yes, perform step 606; otherwise, perform step 607.

Assuming that the total input rate is Bᵢ (where i=1, . . . , M), it is determined whether Bᵢ is lower than the preset first rate, where the preset first rate may be a total input rate at the first one third of a total input rate set after all total input rates in the total input rate set are sorted in an ascending sequence, for example, if the total input rates in the total input rate set are B₁, B₂, B₃, B₄, B₅, and B₆ after being sorted in an ascending sequence, the preset first rate may be set to B₂.

Step 606: Use a lowest rate in a preset high-band rate set as the high-band rate and allocate the high-band rate to the high-band signal, use the remaining rate obtained by subtracting the high-band rate from the total input rate as the low-band rate and allocate the low-band rate to the low-band signal, and perform step 614.

When the total input rate Bᵢ is lower than the preset first rate, the high-band rate of the high-band signal is set to B_{H1}, and the low-band rate of the low-band signal is correspondingly set to Bᵢ−B_{H1}.

Step 607: Use the lowest rate in the high-band rate set as a current high-band rate and allocate the current high-band rate to the high-band signal, where a current low-band rate is correspondingly obtained by subtracting the current high-band rate from the total input rate.

When the coding mode of the low-band signal is not the UC, and the total input rate Bᵢ is not lower than the preset first rate, the current high-band rate of the high-band signal may be set to B_{H1}, where B_{H1} is the lowest rate in the high-band rate set, and correspondingly, the current low-band rate of the low-band signal is Bᵢ−B_{H1}.

In addition to setting the current high-band rate of the high-band signal to B_{H1} as described above, the current high-band rate may also be set to a rate which is in the high-band rate set and is close to a result of Bᵢ*alpha1, where alpha1 may be a preset value, for example, may be ⅓; or, the current low-band rate may also be first set to a rate which is in the low-band rate set and is close to a result of Bᵢ*alpha2, where alpha2 may be a preset value, for example, may be ⅔, and correspondingly, the current high-band rate is Bᵢ−Bi*alpha2. There may be multiple manners for setting the current high-band rate, which are not limited in the embodiment of the present application.

Step 608: Code the low-band signal through a coding mode corresponding to the low-band signal according to the initial low-band rate, to obtain a local low-band composite signal, and calculate a signal-to-noise ratio SNR value of the local low-band composite signal.

Step 609: Determine whether the SNR value is within a preset range, and if no, perform step 610; if yes, perform step 614.

Step 610: When the SNR value is lower than a minimum value of the preset range, adjust the low-band rate to a one-level-high rate of the current low-band rate in the low-band rate set in which low-band rates are sorted according to an ascending sequence, when the SNR value is greater than a maximum value of the preset range, adjust the low-band rate to a one-level-low rate of the current low-band rate in the low-band rate set in which low-band rates are sorted according to an ascending sequence.

Step 611: Code the low-band signal through a coding mode corresponding to the low-band signal according to the low-band rate after the adjustment, to obtain a local low-band composite signal, and re-calculate an SNR value of the local low-band composite signal.

Step 612: Determine whether the re-calculated SNR value is within the preset range, and if no, return to step 610; if yes, perform step 613.

Step 613: Use the low-band rate after the adjustment as the low-band rate of the low-band signal, and correspondingly use a rate obtained by subtracting the low-band rate after the adjustment from the total input rate as the high-band rate of the high-band signal.

Step 614: Code the low-band signal through a coding mode corresponding to the low-band signal according to the allocated low-band rate, and code the high-band signal through a coding mode corresponding to the high-band signal according to the allocated high-band rate.

Processes for coding the high-band signal and the low-band signal in the present application are the same as those in the prior art, and are not repeatedly described here. Code streams after the high-band signal and the low-band signal are coded are multiplexed subsequently, and then a composite bit stream is output, thereby completing the coding processes.

In the second embodiment to fifth embodiment of the audio coding method, after it is determined that the total input rate is not lower than the preset first rate, it may be further determined whether the total input rate is greater than a preset second rate. When the total input rate is greater than the second rate, the high-band rate of the high-band signal may be set to a highest rate in the preset high-band rate set, and the remaining rate obtained by subtracting the set high-band rate from the total input rate is used as the low-band rate and is allocated to the low-band signal. When the total input rate is within a range limited by the foregoing two preset rates, when an original total input rate is lower than the preset first rate, an adaptive adjustment process is performed.

Corresponding to the embodiments of the audio coding method according to the present application, the present application further provides an embodiment of an audio coding apparatus.

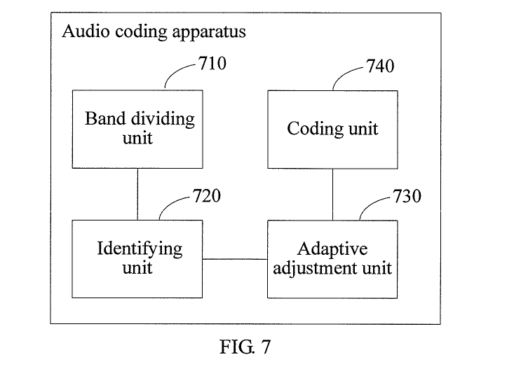

Referring to FIG. 7, FIG. 7 is a block diagram of an embodiment of an audio coding apparatus according to the present application.

The audio coding apparatus includes: a band dividing unit 710, an identifying unit 720, an adaptive adjustment unit 730, and a coding unit 740.

The band dividing unit 710 is configured to divide an input audio signal into a low-band signal and a high-band signal.

The identifying unit 720 is configured to identify types of the low-band signal and the high-band signal, where low-band signals and high-band signals of different types correspond to different coding modes respectively.

The adaptive adjustment unit 730 is configured to adaptively allocate a total input rate of the audio signal to the low-band signal and the high-band signal according to different coding modes corresponding to the low-band signal and the high-band signal, where a low-band rate is allocated to the low-band signal, and a high-band rate is allocated to the high-band signal.

The coding unit 740 is configured to code the low-band signal through a coding mode corresponding to the low-band signal according to the low-band rate, and code the high-band signal through a coding mode corresponding to the high-band signal according to the high-band rate.

The coding modes corresponding to the low-band signals of different types include a audio coding mode and a music audio coding mode, where the audio coding mode includes: a transition coding TC mode, a generic coding GC mode, a voiced coding VC mode, and an unvoiced coding UC mode. The coding modes corresponding to the high-band signals of different types include: a noise coding Noise mode, a transient coding Transient mode, a harmonic coding Harmonic mode, and a normal coding Normal mode. In addition, the Normal mode may also be further classified according to a requirement and specified coding and decoding methods. It should be noted that, the coding modes of the high-band signal and the low-band signal are all classified according to different types of the audio signal, and in an actual application process, it is not limited to the foregoing classification mode, that is, more coding modes may be obtained by further classification according to types of signals.

Furthermore, the adaptive adjustment unit may include: a first rate allocation unit (not shown in FIG. 7), configured to use a lowest rate in a preset high-band rate set as the high-band rate and allocate the high-band rate to the high-band signal, and use the remaining rate obtained by subtracting the high-band rate from the total input rate as the low-band rate and allocate the low-band rate to the low-band signal.

The first rate allocation unit is specifically configured to: when a coding mode corresponding to the type of the low-band signal is not the UC mode, use the lowest rate in the preset high-band rate set as the high-band rate and allocate the high-band rate to the high-band signal, when the coding mode corresponding to the type of the low-band signal is the UC mode, use a lowest rate in a preset low-band rate set as the low-band rate and allocate the low-band rate to the low-band signal, and use the remaining rate obtained by subtracting the low-band rate from the total input rate as the high-band rate and allocate the high-band rate to the high-band signal.

The first rate allocation unit may further include: an initial high-band rate allocation unit, configured to: when the total input rate is greater than or equal to a preset first rate, use the lowest rate in the high-band rate set as an initial high-band rate and allocate the initial high-band rate to the high-band signal; and a rate allocation and adjustment unit, configure to: when the coding mode corresponding to the high-band signal accords with a rate adjustment type, use an adjustment rate which corresponds to the coding mode of the high-band signal and is greater than the initial high-band rate as the high-band rate and allocate the high-band rate to the high-band signal, and use the remaining rate obtained by subtracting the high-band rate from the total input rate as the low-band rate and allocate the low-band rate to the low-band signal.

Furthermore, the adaptive adjustment unit may include a determining unit (not shown in FIG. 7) and a rate allocation unit (not shown in FIG. 7). The rate allocation unit is configured to: when the determining unit determines that the coding mode corresponding to the type of the low-band signal is the UC mode, use the lowest rate in the preset low-band rate set as the low-band rate and allocate the low-band rate to the low-band signal, and use the remaining rate obtained by subtracting the low-band rate from the total input rate as the high-band rate and allocate the high-band rate to the high-band signal.

Furthermore, the rate allocation unit is further configured to: when the determining unit determines that the coding mode corresponding to the type of the low-band signal is not the UC mode, and the total input rate is lower than the preset first rate, use the lowest rate in the preset high-band rate set as the high-band rate and allocate the high-band rate to the high-band signal, and use the remaining rate obtained by subtracting the high-band rate from the total input rate as the low-band rate and allocate the low-band rate to the low-band signal.

Furthermore, the adaptive adjustment unit may further include a first rate adjustment unit (not shown in FIG. 7). The rate allocation unit is further configured to: when the determining unit determines that the total input rate is not lower than the first rate, use the lowest rate in the high-band rate set as an initial high-band rate and allocate the initial high-band rate to the high-band signal. The determining unit is further configured to determine whether the coding mode corresponding to the type of the high-band signal is the Harmonic mode. The first rate adjustment unit is configured to: when a determination result of the determining unit is yes, adjust the high-band rate to a one-level-high rate of the initial high-band rate in the high-band rate set in which high-band rates are sorted in an ascending sequence, and use the remaining rate obtained by subtracting the one-level-high rate from the total input rate as the low-band rate and allocate the low-band rate to the low-band signal. The rate allocation unit is further configured to: when the determination result of the determining unit is no, use the initial high-band rate as the high-band rate, and use the remaining rate obtained by subtracting the initial high-band rate from the total input rate as the low-band rate and allocate the low-band rate to the low-band signal.

Furthermore, the adaptive adjustment unit may further include a second rate adjustment unit (not shown in FIG. 7). The rate allocation unit is further configured to: when the determining unit determines that the total input rate is not lower than the first rate, use the lowest rate in the high-band rate set as an initial high-band rate and allocate the initial high-band rate to the high-band signal. The determining unit is further configured to determine whether the coding mode corresponding to the type of the high-band signal is the Harmonic mode and whether a harmonic of the low-band signal is lower than a threshold and the coding mode corresponding to the type of the low-band signal is the audio coding mode. The second rate adjustment unit is configured to: when a determination result of the determining unit is yes, adjust the high-band rate to a two-level-high rate of the initial high-band rate in the high-band rate set in which high-band rates are sorted in an ascending sequence, and use the remaining rate obtained by subtracting the two-level-high rate from the total input rate as the low-band rate and allocate the low-band rate to the low-band signal. The determining unit is further configured to: when the determination result of the determining unit is no, determine whether the coding mode corresponding to the type of the high-band signal is the Normal mode and whether the harmonic of the low-band signal is lower than the threshold, and the coding mode corresponding to the type of the low-band signal is the audio coding mode. The second rate adjustment unit is further configured to: when a determination result of the determining unit is yes, adjust the high-band rate to a one-level-high rate of the initial high-band rate in the high-band rate set in which high-band rates are sorted in an ascending sequence, and use the remaining rate obtained by subtracting the one-level-high rate from the total input rate as the low-band rate and allocate the low-band rate to the low-band signal. The rate allocation unit is further configured to: when the determination result of the determining unit is no, use the initial high-band rate as the high-band rate, and use the remaining rate obtained by subtracting the initial high-band rate from the total input rate as the low-band rate and allocate the low-band rate to the low-band signal.

Furthermore, the adaptive adjustment unit may further include a third rate adjustment unit (not shown in FIG. 7). The rate allocation unit is further configured to: when the determining unit determines that the total input rate is not lower than the first rate, use the lowest rate in the high-band rate set as an initial high-band rate and allocate the initial high-band rate to the high-band signal. The determining unit is further configured to determine whether the coding mode corresponding to the type of the low-band signal is not the VC mode and whether the coding mode corresponding to the type of high-band signal is the Harmonic mode. The third rate adjustment unit is configured to: when a determination result of the determining unit is yes, adjust the high-band rate to a one-level-high rate of the initial high-band rate in the high-band rate set in which high-band rates are sorted in an ascending sequence, and use the remaining rate obtained by subtracting the one-level-high rate from the total input rate as the low-band rate and allocate the low-band rate to the low-band signal. The determining unit is further configured to: when the determination result of the determining unit is no, determine whether the coding mode corresponding to the type of the low-band signal is the VC mode and whether the coding mode corresponding to the type of high-band signal is the Noise mode. The third rate adjustment unit is further configured to: when a determination result of the determining unit is yes, adjust the high-band rate to a one-level-high rate of the initial high-band rate in the high-band rate set in which high-band rates are sorted in an ascending sequence, and use the remaining rate obtained by subtracting the one-level-high rate from the total input rate as the low-band rate and allocate the low-band rate to the low-band signal. The rate allocation unit is further configured to: when the determination result of the determining unit is no, use the remaining rate obtained by subtracting the initial high-band rate from the total input rate as the low-band rate and allocate the low-band rate to the low-band signal.

Furthermore, the adaptive adjustment unit may further include a fourth rate adjustment unit (not shown in FIG. 7) and an SNR calculation unit (not shown in FIG. 7). The rate allocation unit is further configured to: when the determining unit determines that the total input rate is not lower than the first rate, use the lowest rate in the high-band rate set as a current high-band rate and allocate the current high-band rate to the high-band signal, where a current low-band rate is correspondingly obtained by subtracting the current high-band signal from the total input rate. The SNR calculation unit is configured to code the low-band signal through a coding mode corresponding to the low-band signal according to the initial low-band rate, to obtain a local low-band composite signal, and calculate an SNR value of the local low-band composite signal. The determining unit is further configured to determine whether the SNR value is within a preset range. The rate allocation unit is further configured to: when a determination result of the determining unit is yes, use the initial high-band rate as the high-band rate of the high-band signal, and use the initial low-band rate as the low-band rate of the low-band signal. The fourth rate adjustment unit is configured to: when the SNR value is lower than a minimum value of the preset range, adjust the low-band rate to a one-level-high rate of the current low-band rate in the low-band rate set in which low-band rates are sorted according to an ascending sequence, when the SNR value is greater than a maximum value of the preset range, adjust the low-band rate to a one-level-low rate of the current low-band rate in the low-band rate set in which low-band rates are sorted according to an ascending sequence. The SNR calculation unit is further configured to code the low-band signal through a coding mode corresponding to the low-band signal according to the rate after the adjustment, to obtain a local low-band composite signal, and re-calculate an SNR value of the local low-band composite signal. The determining unit is further configured to determine whether the re-calculated SNR value is within the preset range. The rate allocation unit is further configured to: when a determination result of the determining unit is yes, use the low-band rate after the adjustment as the low-band rate of the low-band signal, and correspondingly use a rate obtained by subtracting the low-band rate after the adjustment from the total input rate as the high-band rate of the high-band signal. The fourth rate adjustment unit is further configured to: when the determination result of the determining unit is no, repeatedly execute a function of the fourth rate adjustment unit.

Furthermore, the determining unit is further configured to: after determining that the total input rate is not lower than the first rate, determine whether the total input rate is greater than a preset second rate. The rate allocation unit is further configured to: when a determination result of the determining unit is yes, use a highest rate in the high-band rate set as the high-band rate and allocate the high-band rate to the high-band signal, and use the remaining rate obtained by subtracting the highest rate from the total input rate as the low-band rate and allocate the low-band rate to the low-band signal.

It can be known from the description of the foregoing implementation manners that, in the embodiments of the present application, the input audio signal is divided into the low-band signal and the high-band signal, the total input rate of the audio signal is adaptively allocated to the low-band signal and the high-band signal according to different coding modes corresponding to the low-band signal and the high-band signal, and the low-band signal is coded through the coding mode corresponding to the low-band signal according to the low-band rate, and the high-band signal is coded through the coding mode corresponding to the high-band signal according to the high-band rate. In the embodiments of the present application, when the low-band signal and the high-band signal are coded, the coding is not performed according to a rate given in the standard, and coding rates are adaptively adjusted according to different types of the signals, thereby improving overall audio coding performance.

Persons skilled in the art may clearly understand that, the technique in the embodiments of the present application may be implemented through software and a necessary general hardware platform. Based on such understanding, the technical solutions in the embodiments of the present application essentially, or the part contributing to the prior art may be embodied in the form of a software product. The computer software product may be stored in a storage medium, such as a ROM/RAM, a magnetic disk, or an optical disk, and includes several instructions for instructing a computer device (which may be a personal computer, a server, or a network device, or the like) to perform the methods described in the embodiments of the present application or in some parts of the embodiments of the present application.

The embodiments in this specification are all described in a progressive manner, mutual reference may be made to the same or similar part of the embodiments, and each embodiment focuses on description of a difference from other embodiments. In particular, the apparatus embodiment is described simply because it is basically similar to the method embodiment, and for the relevant part, reference may be made to the part of the description of the method embodiment.

The foregoing description is the embodiments of the present application, but is not intended to limit the protection scope of the present application. Any modification, equivalent replacement and improvement made within the spirit and principle of the present application shall fall within the protection scope of the present application.

What is claimed is:

1. An audio coding method, comprising:
dividing an input audio signal into a low-band signal and a high-band signal;
identifying types of the low-band signal and the high-band signal, wherein low-band signals and high-band signals of different types correspond to different coding modes respectively;
adaptively allocating a total input rate of the audio signal to the low-band signal and the high-band signal according to different coding modes corresponding to the low-band signal and the high-band signal, wherein a low-band rate is allocated to the low-band signal, and a high-band rate is allocated to the high-band signal; and
coding the low-band signal through a coding mode corresponding to the low-band signal according to the low-band rate, and coding the high-band signal through a coding mode corresponding to the high-band signal according to the high-band rate.

2. The method according to claim 1, wherein adaptively allocating a total input rate of the audio signal to the low-band signal and the high-band signal comprises:
using a lowest rate in a preset high-band rate set as the high-band rate and allocating the high-band rate to the high-band signal, and using the remaining rate obtained by subtracting the high-band rate from the total input rate as the low-band rate and allocating the low-band rate to the low-band signal.

3. The method according to claim 2, wherein using a lowest rate in a preset high-band rate set as the high-band rate and allocating the high-band rate to the high-band signal comprises:
when the coding mode corresponding to the type of the low-band signal is not an unvoiced coding (UC) mode, using the lowest rate in the preset high-band rate set as the high-band rate and allocating the high-band rate to the high-band signal.

4. The method according to claim 3, further comprising:
when the coding mode corresponding to the type of the low-band signal is the UC mode, using a lowest rate in a preset low-band rate set as the low-band rate and allocating the low-band rate to the low-band signal, and using the remaining rate obtained by subtracting the low-band rate from the total input rate as the high-band rate and allocating the high-band rate to the high-band signal.

5. The method according to claim 4, further comprising:
when the total input rate is greater than or equal to a preset first rate, using the lowest rate in the high-band rate set as an initial high-band rate and allocating the initial high-band rate to the high-band signal; and
when the coding mode corresponding to the high-band signal accords with a rate adjustment type, using an adjustment rate which corresponds to the coding mode of the high-band signal and is greater than the initial high-band rate as the high-band rate and allocating the high-band rate to the high-band signal, and using the remaining rate obtained by subtracting the high-band rate from the total input rate as the low-band rate and allocating the low-band rate to the low-band signal.

6. The method according to claim 1, wherein adaptively allocating a total input rate of the audio signal to the low-band signal and the high-band signal according to different coding modes corresponding to the low-band signal and the high-band signal comprises:
when the coding mode corresponding to the type of the low-band signal is a UC mode, using a lowest rate in a preset low-band rate set as the low-band rate and allocating the low-band rate to the low-band signal; and
using the remaining rate obtained by subtracting the low-band rate from the total input rate as the high-band rate and allocating the high-band rate to the high-band signal.

7. The method according to claim 6, further comprising:
when the coding mode corresponding to the type of the low-band signal is not the UC mode, and the total input rate is lower than a preset first rate, using a lowest rate in a preset high-band rate set as the high-band rate and allocating the high-band rate to the high-band signal; and
using the remaining rate obtained by subtracting the high-band rate from the total input rate as the low-band rate and allocating the low-band rate to the low-band signal.

8. The method according to claim 7, further comprising:
when it is determined that the total input rate is not lower than the first rate, using the lowest rate in the high-band rate set as an initial high-band rate and allocating the initial high-band rate to the high-band signal; and
determining whether the coding mode corresponding to the type of the high-band signal is a harmonic coding (Harmonic) mode,
when a determination result is yes, adjusting the high-band rate to a one-level-high rate of the initial high-band rate in the high-band rate set in which high-band rates are sorted in an ascending sequence, and using the remaining rate obtained by subtracting the one-level-high rate from the total input rate as the low-band rate and allocating the low-band rate to the low-band signal; and
when the determination result is no, using the initial high-band rate as the high-band rate, and using the remaining rate obtained by subtracting the initial high-band rate from the total input rate as the low-band rate and allocating the low-band rate to the low-band signal.

9. The method according to claim 7, further comprising:
when it is determined that the total input rate is not lower than the first rate, using the lowest rate in the high-band rate set as an initial high-band rate and allocating the initial high-band rate to the high-band signal; and
determining whether the coding mode corresponding to the type of the high-band signal is a Harmonic mode and whether a harmonic of the low-band signal is lower than a threshold and the coding mode corresponding to the type of the low-band signal is an audio coding mode;
when a determination result is yes, adjusting the high-band rate to a two-level-high rate of the initial high-band rate in the high-band rate set in which high-band rates are sorted in an ascending sequence, and using the remaining rate obtained by subtracting the two-level-high rate from the total input rate as the low-band rate and allocating the low-band rate to the low-band signal; and
when the determination result is no, determining whether the coding mode corresponding to the type of the high-band signal is a normal coding (Normal) mode and whether the harmonic of the low-band signal is lower than the threshold, and the coding mode corresponding to the type of the low-band signal is the audio coding mode;
when the determination result is yes, adjusting the high-band rate to a one-level-high rate of the initial high-band rate in the high-band rate set in which high-band rates are sorted in an ascending sequence, and using the remaining rate obtained by subtracting the one-level-high rate from the total input rate as the low-band rate and allocating the low-band rate to the low-band signal; and
when the determination result is no, using the initial high-band rate as the high-band rate, and using the remaining rate obtained by subtracting the initial high-band rate from the total input rate as the low-band rate and allocating the low-band rate to the low-band signal.

10. The method according to claim 7, further comprising:
when it is determined that the total input rate is not lower than the first rate, using the lowest rate in the high-band rate set as an initial high-band rate and allocating the initial high-band rate to the high-band signal; and
determining whether the coding mode corresponding to the type of the low-band signal is not a voiced coding (VC) mode and whether the coding mode corresponding to the type of high-band signal is a Harmonic mode;
when a determination result is yes, adjusting the high-band rate to a one-level-high rate of the initial high-band rate in the high-band rate set in which high-band rates are sorted in an ascending sequence, and using the remaining rate obtained by subtracting the one-level-high rate from the total input rate as the low-band rate and allocating the low-band rate to the low-band signal; and
when the determination result is no, determining whether the coding mode corresponding to the type of the low-band signal is the VC mode and whether the coding mode corresponding to the type of high-band signal is a noise coding (Noise) mode;
when the determination result is yes, adjusting the high-band rate to a one-level-high rate of the initial high-band rate in the high-band rate set in which high-band rates are sorted in an ascending sequence, and using the remaining rate obtained by subtracting the one-level-high rate from the total input rate as the low-band rate and allocating the low-band rate to the low-band signal; and
when the determination result is no, using the remaining rate obtained by subtracting the initial high-band rate from the total input rate as the low-band rate and allocating the low-band rate to the low-band signal.

11. The method according to claim 7, further comprising:
when it is determined that the total input rate is not lower than the first rate, using the lowest rate in the high-band rate set as a current high-band rate and allocating the current high-band rate to the high-band signal, wherein a current low-band rate is correspondingly obtained by subtracting the current high-band rate from the total input rate;
coding the low-band signal through the coding mode corresponding to the low-band signal according to the initial low-band rate, to obtain a local low-band composite signal, and calculating a signal-to-noise ratio (SNR) value of the local low-band composite signal; and
determining whether the SNR value is within a preset range,
when a determination result is yes, using the initial high-band rate as the high-band rate of the high-band signal, and using the initial low-band rate as the low-band rate of the low-band signal; and
when the determination result is no, executing the following adjustment steps: when the SNR value is lower than a minimum value of the preset range, adjusting the low-band rate to a one-level-high rate of the current low-band rate in the low-band rate set in which low-band rates are sorted according to an ascending sequence, when the SNR value is greater than a maximum value of the preset range, adjusting the low-band rate to a one-level-low rate of the current low-band rate in the low-band rate set in which low-band rates are sorted according to an ascending sequence;
coding the low-band signal through the coding mode corresponding to the low-band signal according to the low-band rate after the adjustment, to obtain a local low-band composite signal, and re-calculating an SNR value of the local low-band composite signal; and
determining whether the re-calculated SNR value is within the preset range,
when the determination result is yes, using the low-band rate after the adjustment as the low-band rate of the low-band signal, and correspondingly using a rate obtained by subtracting the low-band rate after the adjustment from the total input rate as the high-band rate of the high-band signal; and
when the determination result is no, returning to execute the adjustment steps.

12. The method according to claim 8, wherein after determining that the total input rate is not lower than the first rate, the method further comprises:
determining whether the total input rate is greater than a preset second rate,
when the determination result is yes, using a highest rate in the high-band rate set as the high-band rate and allocating the high-band rate to the high-band signal, and using the remaining rate obtained by subtracting the highest rate from the total input rate as the low-band rate and allocating the low-band rate to the low-band signal; and
when the determination result is no, executing the step of allocating the lowest rate in the high-band rate set to the high-band signal.

13. An audio coding apparatus, comprising:
a band dividing unit, configured to divide an input audio signal into a low-band signal and a high-band signal;
an identifying unit, configured to identify types of the low-band signal and the high-band signal, wherein low-band signals and high-band signals of different types correspond to different coding modes respectively;
an adaptive adjustment unit, configured to adaptively allocate a total input rate of the audio signal to the low-band signal and the high-band signal according to different coding modes corresponding to the low-band signal and the high-band signal, wherein a low-band rate is allocated to the low-band signal, and a high-band rate is allocated to the high-band signal; and
a coding unit, configured to code the low-band signal through a coding mode corresponding to the low-band signal according to the low-band rate, and code the high-band signal through a coding mode corresponding to the high-band signal according to the high-band rate.

14. The apparatus according to claim 13, wherein the adaptive adjustment unit comprises:
a first rate allocation unit, configured to use a lowest rate in a preset high-band rate set as the high-band rate and allocate the high-band rate to the high-band signal, and use the remaining rate obtained by subtracting the high-band rate from the total input rate as the low-band rate and allocate the low-band rate to the low-band signal.

15. The apparatus according to claim 14, wherein the first rate allocation unit is configured to: when the coding mode corresponding to the type of the low-band signal is not an unvoiced coding (UC) mode, use the lowest rate in the preset high-band rate set as the high-band rate and allocate the high-band rate to the high-band signal, when the coding mode corresponding to the type of the low-band signal is the UC mode, use a lowest rate in a preset low-band rate set as the low-band rate and allocate the low-band rate to the low-band signal, and use the remaining rate obtained by subtracting the low-band rate from the total input rate as the high-band rate and allocate the high-band rate to the high-band signal.

16. The apparatus according to claim 15, wherein the first rate allocation unit comprises:
an initial high-band rate allocation unit, configured to: when the total input rate is greater than or equal to a preset first rate, use the lowest rate in the high-band rate set as an initial high-band rate and allocate the initial high-band rate to the high-band signal; and
a rate allocation and adjustment unit, configure to: when the coding mode corresponding to the high-band signal accords with a rate adjustment type, use an adjustment rate which corresponds to the coding mode of the high-band signal and is greater than the initial high-band rate as the high-band rate and allocate the high-band rate to the high-band signal, and use the remaining rate obtained by subtracting the high-band rate from the total input rate as the low-band rate and allocate the low-band rate to the low-band signal.

17. The apparatus according to claim 13, wherein the adaptive adjustment unit comprises a determining unit and a rate allocation unit, wherein
the rate allocation unit is configured to: when the determining unit determines that the coding mode corresponding to the type of the low-band signal is a UC mode, use a lowest rate in a preset low-band rate set as the low-band rate and allocate the low-band rate to the low-band signal, and use the remaining rate obtained by subtracting the low-band rate from the total input rate as the high-band rate and allocate the high-band rate to the high-band signal.

18. The apparatus according to claim 17, wherein
the rate allocation unit is further configured to: when the determining unit determines that the coding mode corresponding to the type of the low-band signal is not the UC mode, and the total input rate is lower than a preset first rate, use a lowest rate in a preset high-band rate set as the high-band rate and allocate the high-band rate to the high-band signal, and use the remaining rate obtained by subtracting the high-band rate from the total input rate as the low-band rate and allocate the low-band rate to the low-band signal.

19. The apparatus according to claim 18, wherein the adaptive adjustment unit further comprises a first rate adjustment unit, wherein
the rate allocation unit is further configured to: when the determining unit determines that the total input rate is not lower than the first rate, use the lowest rate in the high-band rate set as an initial high-band rate and allocate the initial high-band rate to the high-band signal;
the determining unit is further configured to determine whether the coding mode corresponding to the type of the high-band signal is a harmonic coding (Harmonic) mode;
the first rate adjustment unit is configured to: when a determination result of the determining unit is yes, adjust the high-band rate to a one-level-high rate of the initial high-band rate in the high-band rate set in which high-band rates are sorted in an ascending sequence, and use the remaining rate obtained by subtracting the one-level-high rate from the total input rate as the low-band rate and allocate the low-band rate to the low-band signal; and
the rate allocation unit is further configured to: when the determination result of the determining unit is no, use the initial high-band rate as the high-band rate, and use the remaining rate obtained by subtracting the initial high-band rate from the total input rate as the low-band rate and allocate the low-band rate to the low-band signal.

20. The apparatus according to claim 18, wherein the adaptive adjustment unit further comprises a second rate adjustment unit, wherein
the rate allocation unit is further configured to: when the determining unit determines that the total input rate is not lower than the first rate, use the lowest rate in the high-band rate set as an initial high-band rate and allocate the initial high-band rate to the high-band signal;
the determining unit is further configured to determine whether the coding mode corresponding to the type of the high-band signal is a Harmonic mode and whether a harmonic of the low-band signal is lower than a threshold and the coding mode corresponding to the type of the low-band signal is an audio coding mode;
the second rate adjustment unit is configured to: when a determination result of the determining unit is yes, adjust the high-band rate to a two-level-high rate of the initial high-band rate in the high-band rate set in which high-band rates are sorted in an ascending sequence, and use the remaining rate obtained by subtracting the two-level-high rate from the total input rate as the low-band rate and allocate the low-band rate to the low-band signal; and
the determining unit is further configured to: when the determination result of the determining unit is no, determine whether the coding mode corresponding to the type of the high-band signal is a normal coding (Normal) mode and whether harmonic of the low-band signal is lower than a threshold and the coding mode corresponding to the type of the low-band signal is the audio coding mode;
the second rate adjustment unit is further configured to: when a determination result of the determining unit is yes, adjust the high-band rate to a one-level-high rate of the initial high-band rate in the high-band rate set in which high-band rates are sorted in an ascending sequence, and use the remaining rate obtained by subtracting the one-level-high rate from the total input rate as the low-band rate and allocate the low-band rate to the low-band signal; and
the rate allocation unit is further configured to: when the determination result of the determining unit is no, use the initial high-band rate as the high-band rate, and use the remaining rate obtained by subtracting the initial high-band rate from the total input rate as the low-band rate and allocate the low-band rate to the low-band signal.

21. The apparatus according to claim 18, wherein the adaptive adjustment unit further comprises a third rate adjustment unit, wherein
the rate allocation unit is further configured to: when the determining unit determines that the total input rate is not lower than the first rate, use the lowest rate in the high-band rate set as an initial high-band rate and allocate the initial high-band rate to the high-band signal;
the determining unit is further configured to determine whether the coding mode corresponding to the type of the low-band signal is not a voiced coding (VC) mode and whether the coding mode corresponding to the type of high-band signal is a Harmonic mode;
the third rate adjustment unit is configured to: when a determination result of the determining unit is yes, adjust the high-band rate to a one-level-high rate of the initial high-band rate in the high-band rate set in which high-band rates are sorted in an ascending sequence, and use the remaining rate obtained by subtracting the one-level-high rate from the total input rate as the low-band rate and allocate the low-band rate to the low-band signal; and
the determining unit is further configured to: when the determination result of the determining unit is no, determine whether the coding mode corresponding to the type of the low-band signal is the VC mode and whether the coding mode corresponding to the type of high-band signal is a noise coding (Noise) mode;
the third rate adjustment unit is further configured to: when a determination result of the determining unit is yes, adjust the high-band rate to a one-level-high rate of the initial high-band rate in the high-band rate set in which high-band rates are sorted in an ascending sequence, and use the remaining rate obtained by subtracting the one-level-high rate from the total input rate as the low-band rate and allocate the low-band rate to the low-band signal; and
the rate allocation unit is further configured to: when the determination result of the determining unit is no, use the remaining rate obtained by subtracting the initial high-band rate from the total input rate as the low-band rate and allocate the low-band rate to the low-band signal.

22. The apparatus according to claim 18, wherein the adaptive adjustment unit further comprises a fourth rate adjustment unit and a signal-to-noise ratio (SNR) calculation unit, wherein
the rate allocation unit is further configured to: when the determining unit determines that the total input rate is not lower than the first rate, use the lowest rate in the high-band rate set as a current high-band rate and allocate the current high-band rate to the high-band signal, wherein a current low-band rate is correspondingly obtained by subtracting the current high-band signal from the total input rate;
the SNR calculation unit is configured to code the low-band signal through a coding mode corresponding to the low-band signal according to the initial low-band rate, to obtain a local low-band composite signal, and calculate an SNR value of the local low-band composite signal; and
the determining unit is further configured to determine whether the SNR value is within a preset range, wherein
the rate allocation unit is further configured to: when a determination result of the determining unit is yes, use the initial high-band rate as the high-band rate of the high-band signal, and use the initial low-band rate as the low-band rate of the low-band signal; and
the fourth rate adjustment unit is configured to: when the SNR value is lower than a minimum value of the preset range, adjust the low-band rate to a one-level-high rate of the current low-band rate in the low-band rate set in which low-band rates are sorted according to an ascending sequence, when the SNR value is greater than a maximum value of the preset range, adjust the low-band rate to a one-level-low rate of the current low-band rate in the low-band rate set in which low-band rates are sorted according to an ascending sequence;
the SNR calculation unit is further configured to code the low-band signal through a coding mode corresponding to the low-band signal according to the low-band rate after the adjustment, to obtain a local low-band composite signal, and re-calculate an SNR value of the local low-band composite signal; and
the determining unit is further configured to determine whether the re-calculated SNR value is within the preset range,
the rate allocation unit is further configured to: when a determination result of the determining unit is yes, use the low-band rate after the adjustment as the low-band rate of the low-band signal, and correspondingly use a rate obtained by subtracting the low-band rate after the adjustment from the total input rate as the high-band rate of the high-band signal; and
the fourth rate adjustment unit is further configured to: when the determination result of the determining unit is no, repeatedly execute a function of the fourth rate adjustment unit.

23. The apparatus according to claim 19, wherein
the determining unit is further configured to: after determining that the total input rate is not lower than the first rate, determine whether the total input rate is greater than a preset second rate; and
the rate allocation unit is further configured to: when a determination result of the determining unit is yes, use a highest rate in the high-band rate set as the high-band rate and allocate the high-band rate to the high-band signal, and use the remaining rate obtained by subtracting the highest rate from the total input rate as the low-band rate and allocate the low-band rate to the low-band signal.
